(19) United States
(12) Patent Application Publication
(10) Pub. No.: US 2005/0086184 A1
(43) Pub. Date: Apr. 21, 2005

(54) Method and apparatus for intelligent accessory suggestions

(76) Inventors: Donald J. Stavely, Windsor, CO (US); Andrew C. Goris, Loveland, CO (US); Linda A. Kennedy, Fort Collins, CO (US); Beth Moses, Windsor, CO (US); George Prokop, Loveland, CO (US); Robert F. Yockey, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/690,786

(22) Filed: Oct. 21, 2003

(51) Int. Cl. G06E 1/00

(52) U.S. Cl. 706/15

(57) ABSTRACT

A device that monitors the way in which the device is being used is disclosed. When an accessory is available for the device that would complement the use detected, the availability of the accessory is communicated to the user.

### FIELD OF THE INVENTION

The field of this invention relates to digital devices.

### BACKGROUND OF THE INVENTION

Digital devices are in widespread use today. Many of these devices have accessories that aid in the use of these devices. Unfortunately, the user of the device may not know that accessories are available. Some of the accessories may only help in the use of the device in a limited set of circumstances. Some of the accessories available for the device may not help the user. For example, a zoom lens will not help someone that only takes photos indoors. The user typically does not wish to be informed about accessories that will not aid them in the use of the device.

Therefore there is a need for a device that can detect one or more common operating modes of the device and suggest the accessories available that will aid in that operating mode.

### SUMMARY OF THE INVENTION

A device that monitors the way in which the device is being used is disclosed. When an accessory is available for the device that would complement the use detected, the availability of the accessory is communicated to the user.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 is a block diagram of a digital camera that could implement an example embodiment of the present invention.

FIG. 2 is a block diagram of a scanner that could implement an example embodiment of the present invention.

FIG. 3 is a flow chart for monitoring a usage model and suggesting an accessory in an example embodiment of the present invention.

### DETAILED DESCRIPTION OF THE PREFERRED EMBODIMENT

Digital devices are in widespread use today. Many of these devices have accessories that aid in the use of these devices. Many of the accessories only provide help when using the device in a limited number of usage models. Many consumers don't know how they will use the device at the time they purchase the device. Unfortunately the information about the accessories for the device are typically made available just before, or at the time of purchase. Once the user starts using the device in a particular way, they may have forgotten, or may have never known, that an accessory is available that would aid them for that particular way of using the device.

In one example embodiment of the current invention, when a device detects that it's being used in a particular way and there is an accessory that would complement the device for the current use. The device will inform the user that the accessory is available. The device may also inform the user why the accessory would help the user for that particular use. In another example embodiment, it may not be the device that informs the user about the accessory. For example, the device may be connected to a computer and the computer may inform the user about the accessory.

Some devices are typically connected to a computer when they are in use, for example, most scanners are connected to a computer when they are in use. Some devices are not typically connected to computers during their use, but are connected to computers to unload or display information that the device has captured, for example, a digital camera. In the preferred embodiment, devices that are typically attached, and controlled from, a computer during use will have the computer inform the user about the accessory. In the preferred embodiment, devices that are not typically attached to a computer during use, will have the device inform the user about the accessory.

Many different devices may be used to implement this invention. Any device that can monitor how it is used, and that has accessories that may aid in some of those uses, can implement this invention. The invention can be implemented on, but is not limited to, the following types of devices: digital cameras, scanners, PDA's, cell phones, MP3 players, and printers. The types of accessories available are dependent on the type of device. For example, a digital camera may have: a tripod, a flash, additional memory, a wireless link, a zoom lens, and a wide angle lens available as an accessory. Scanners may have: automatic document feeders, transparency adaptors, photo feeders, and negative adaptors available as accessories. PDA's may have: wireless links, additional memory, and earphones available as accessories. Cell phones may have: earphones, 12 volt chargers, and hands free operating modes. MP3 players may have: additional memory, high quality headphones, external speakers, and higher capacity batteries. Printers may have larger paper trays, transparency adaptors, sorters, staplers, and hole punchers. These are just examples of the types of accessories available for some of the types of devices that may implement this invention.

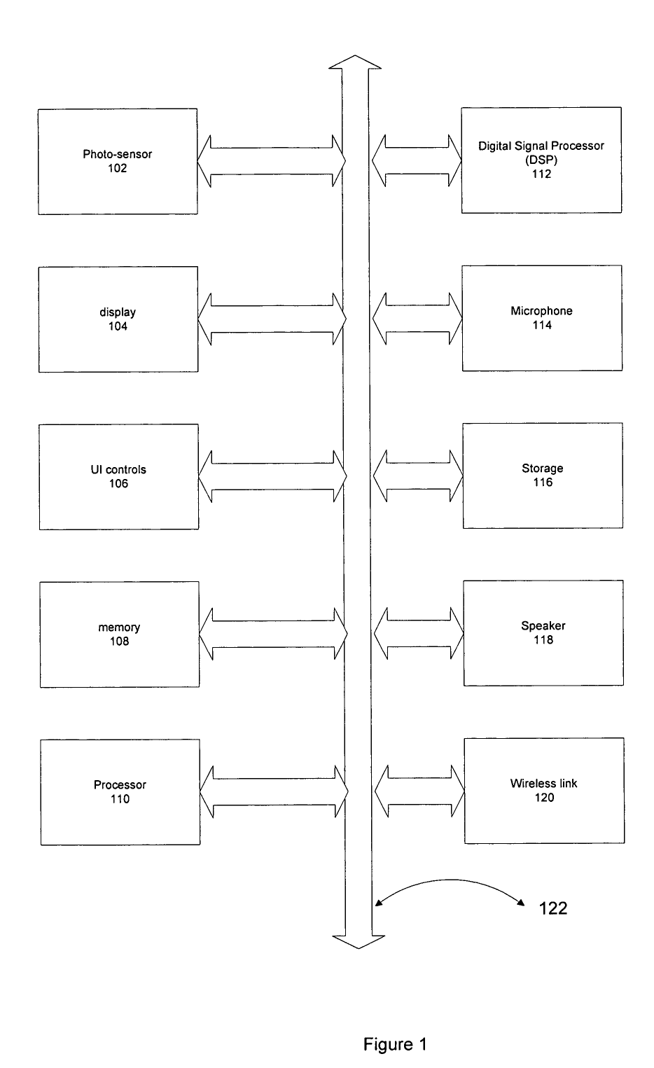

In one example embodiment, a digital camera will implement this invention. An electronic block diagram of a typical digital camera is shown in FIG. 1. Digital cameras today typically contain a photo-sensor (102) for capturing images; a display area (104) for displaying the captured images and controlling the digital camera; a storage area (116) for storing the captured images; memory (108), for temporary manipulation of the captured images and for running the firmware of the camera; a processor (110) for controlling the camera, and some type of controls (106). Some digital cameras also include a microphone (114) for capturing audio clips along with the digital images. Some digital cameras include a speaker (118) and a digital signal processor (DSP) (112). The controls (106) on digital cameras may include physical controls like buttons, rocker switches, and a keyboard, and virtual controls shown in the display area. The digital images, video clips and audio clips captured by the digital camera may be stored in memory (108) or may be moved to the storage area (116). Today the memory and the storage area are typically different types of devices. The memory is typically fast volatile memory and the storage area is typically slower non-volatile memory. In the future, as the speed of non-volatile memory increases, all the memory may be of the non-volatile type. Digital imaging devices typically have an input/output (I/O) channel (122). This I/O channel may be, for example, a USB bus, a SCSI bus, an IR link, Fire Wire, or a parallel link. The I/O channel is used to connect the digital imaging device to other computer systems or networks. Some digital imaging devices connect to other computer systems using a camera dock. Digital cameras may also contain a wireless link (120) to the Internet, for example a cell phone an integrated with a digital camera.

In one example embodiment of the current invention, the processor (110) monitors the settings of the device, in this case the digital camera. The settings for a camera that are monitored may include, but are not limited to, the focus position of the lens (not shown), the amount of zoom (optical and electronic), the aperture setting, the flash settings (off or on, and how much power if on), the amount of ambient light, the focus signal, the shutter speed, the exposure time for the photo sensor (102), if the camera is in burst mode, if sound is being captured, the time and date of the captured images, the time interval between captured images, how often the memory is exchanged, and the resolution captured. These settings may be stored in memory (108), in storage (116), or may be stored as part of the captured image, or some combination thereof. After the processor (110) detects a predetermined combination of settings, the processor will display information about an accessory that is available for the camera. Different accessories may have different predetermined combinations of settings that the processor detects. For example, when the processor detects low levels of ambient light, the processor may suggest a flash as an accessory for the device. When the processor detects long exposure times or high levels of zoom, a tripod may be suggested as an accessory to the camera. When the processor detects that the memory card is filled quickly, a larger memory card may be suggested as the accessory. Some accessories may be suggested for multiple predetermined combinations of settings. For example, a flash may be suggested for low levels of ambient light. The flash may also be suggested when quick exposure times still result in blurry images. This may correspond to fast action photos where a flash would help stop the action. Some preset combination of settings may have multiple accessories suggested. For example, high levels of digital zoom may have a tripod and a zoom lens suggested as accessories for the camera.

In some cases it may be obvious why an accessory is being suggested. In other cases it may not be apparent why an accessory is being suggested. For example, some people don't know that a flash will help freeze the action of a fast moving scene. In one example embodiment the device will not only suggest an accessory but will also inform the user why the accessory is being suggested.

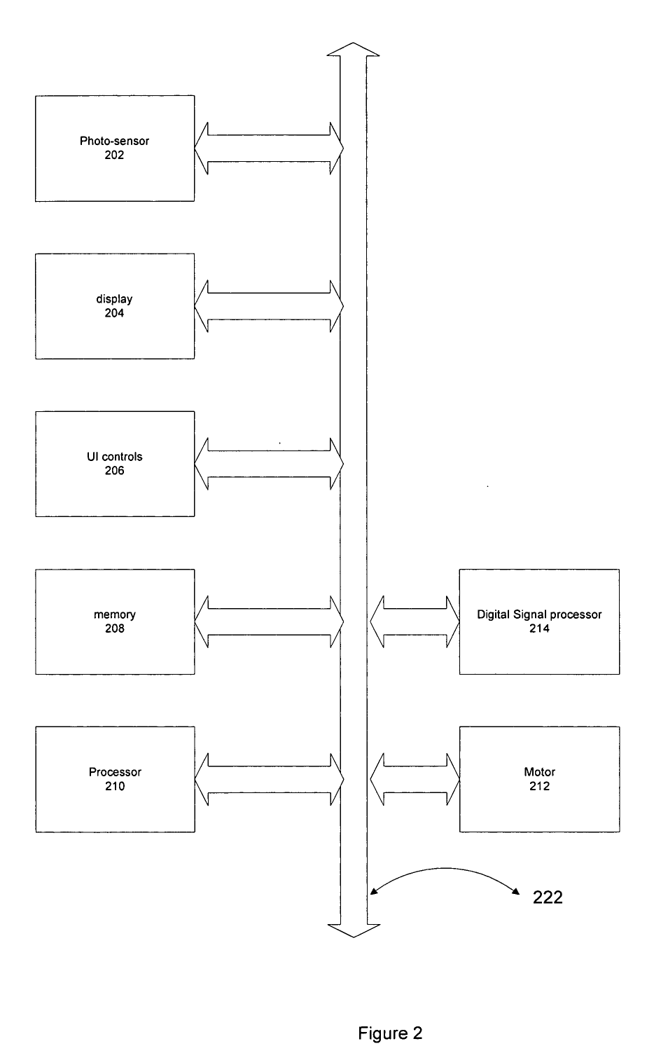

In one example embodiment of the current invention, the device will be a scanner. FIG. 2 shows an electronic block diagram of a scanner that could implement an example embodiment of the current invention. The scanner has a photo sensor (202), a display (204), some user interface (UI) controls. Typically the UI controls on scanners are buttons and switches. The scanner contains some memory (208) for temporary storage of scan data. The scanner typically contains a motor (212) to move the photo-sensor relative to the object to be scanned. The scanner contains a processor (210) that controls the functionality of the scanner. The scanner may contain a DSP (214) to process the scan data. The scanner will typically have an I/O channel (222). This I/O channel may be, for example, a USB bus, a SCSI bus, an IR link, Fire Wire, or a parallel link. The I/O channel is used to connect the scanner to a computer system or a network. Most scanners today have a program that operates on the computer (not shown) the scanner is connected to, to help operate the scanner.

Today most scanners can save scans as images or convert the scan of a page into text using optical character recognition (OCR). Many scanners automatically detect when the page is text or when the scan contains images. In other scanners the user sets the type of scan to be done. When the scanner detects that multiple pages of text are being scanned in a relatively short amount of time, the scanner may suggest that an automatic document feeder is available. Scanning text documents in a rapid sequence is one usage model for a scanner. Another usage model is scanning multiple images. In this case the scanner may detect that all the scans result are color images. The size of the scans may also all be the same, for example 4×5. In this case the scanner may suggest that a photo-feeder is available as an accessory. Because a scanner is typically connected to a computer during use, the computer will be the device that detects the usage model for the preferred embodiment of this example embodiment.

In one example embodiment of the current invention, the device will be a cell phone. Cell phones typically contain a processor, memory, a display, and some UI controls. Cell phones can detect the location of the call. When the cell phone detects that the location of the call is moving at the speed of a typical car, or that calls originate from many locations, the cell phone can display information about a number of accessories. For example, the cell phone can display information about a 12 volt charging system for the car. The cell phone may also display information about a hands free operating mode. The cell phone can also monitor the length of the call. When the length of a call exceeds a threshold amount, the cell phone may display information about a headset as an accessory.

In one example embodiment of the current invention, the device will be a MP3 player. MP3 players typically contain a processor, memory, a display, and some UI controls. MP3 players can monitor the amount of memory available in the device. If the amount falls below a threshold, a higher capacity memory device can be suggested as an accessory. The MP3 player can monitor the frequency content of the music played, and suggest higher quality headphones as an accessory when full spectrum music is detected. The MP3 player may also suggest a subwoofer as an accessory when it detects music with a high base content.

In one example embodiment of the current invention, the device will be a printer. Printers typically contain a processor, memory, a display, and some UI controls. Printers can monitor how often the paper tray is empty. When the interval between when the paper tray is empty goes below a threshold, the printer can inform the user that a larger paper tray is available as an accessory. Many printers allow the manual feeding for different sized paper. When different sizes of paper are being manually fed, for example legal size paper, then an optional legal size paper tray may be suggested. Many printers suggest replacing ink cartridges when the current cartridge is low on ink. Additionally, the printer or printer software may monitor the rate of ink consumption, and suggest larger capacity cartridges. The printer or software may detect the frequent printing of images (based on color content and density), and suggest photo ink cartridges or photo paper.

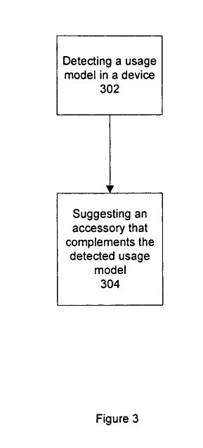

FIG. 3 show a flow chart for one example embodiment of the current invention. At step 302 the device detects a usage model in a device. At step 304 an accessory to the device is suggested, where the accessory would complement the usage model. In one example embodiment of the current invention, the accessory may be suggested after the usage model or mode is detected for the first time. In another example embodiment of the current invention, the accessory may be suggested after the usage model or mode is detected for a preset number of times, for example 5 times. In another example embodiment of the current invention, the device will track a plurality of usage models. When one of the usage models has been used a predetermined number of times, an accessory for the device will be suggested.

The information about the types of accessories available for each type of device may be stored in the device, or it may be stored in a compute that the device connects to, or it may be stored on the internet and accessed by the device, or some combination of the above. It is well know in the arts how a device can access information from the internet.

The information about the purchase location for the accessories suggested for each type of device may be stored in the device, or it may be stored in a compute that the device connects to, or it may be stored on the internet and accessed by the device, or some combination of the above. It is well know in the arts how a device can access information from the internet.

The foregoing description of the present invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

1. A method comprising:
detecting a usage model in a device;
suggesting at least one accessory that complements the usage model.

2. The method of claim 1 where the suggestion is made after the usage model is detected a predetermined number of times.

3. The method of claim 1 where the device suggests the accessory.

4. The method of claim 1 where the device detects the usage model.

5. The method of claim 1 where the accessory is configured to operate with the device.

6. The method of claim 1 where the device identifies why the accessory would be complementary for the detected usage model.

7. The method of claim 1 where at least one location where the accessory can be purchased is identified.

8. The method of claim 7 where the at least one location where the accessory can be purchased is a web site.

9. The method of claim 1 where the device is a digital camera.

10. The method of claim 1 where the device is a scanner.

11. The method of claim 1 where the device is a printer.

12. The method of claim 1 where the device is a PDA.

13. The method of claim 1 where the device is a digital phone.

14. The method of claim 1 where the device is an MP3 player.

15. A method comprising:
tracking a frequency of use for a plurality of usage models in a device;
suggesting at least one accessory for the device when the frequency of use of a usage model reaches a predetermined number.

16. The method of claim 15 where the accessory is suggested for a usage model with the highest frequency of use.

17. The method of claim 15 where the device is a digital camera.

18. The method of claim 15 where the device is a scanner.

19. The method of claim 15 where the device is a printer.

20. The method of claim 15 where the device is a PDA.

21. The method of claim 15 where the device is a digital phone.

22. The method of claim 15 where at least one location where the accessory can be purchased is disclosed.

23. The method of claim 22 where the at least one location where the accessory can be purchased is a web site.

24. A method comprising:
tracking the usage of a camera;
suggesting an accessory for the camera based on the tracked use.

25. A method comprising:
detecting when a digital camera is used in a predetermined mode;
automatically suggesting at least one accessory for the digital camera that corresponds to the usage of the predetermined mode.

26. The method of claim 25 where the suggestion occurs after the digital camera has been used in the predetermined mode a preset number of times.

27. The method of claim 25 where the accessory is selected from the group consisting of: a tripod, a lens filter, a flash, a memory device, a wireless link, a zoom lens, a wide angle lens, a lens hood, a cleaning kit, a tele-extender lens.

28. A device, comprising:
a processor configured to monitor a plurality of settings in the device;
the processor configured to analyze the plurality of settings to detect when a predetermined combination of the settings occur;
a display, the processor configured to display information, on the display, about an accessory for the device, after the predetermined combination of settings is detected.

29. The device of claim 28 where the device is a digital camera.

30. The device of claim 28 where the device is a scanner.

31. The device of claim 28 where the device is a printer.

32. The device of claim 28 where the device is a PDA.

33. The device of claim 28 where the device is a digital phone.

34. The device of claim 28 where the device is a MP3 player.

35. The device of claim 28 where the suggestion is made after the predetermined combination of settings is detected a predetermined number of times.

36. The device of claim 28 where the device identifies at least one location where the accessory can be purchased.

37. The device of claim 36 where the at least one location where the accessory can be purchased is a web site.

38. A device, comprising:
a means for detecting a predetermined use of the device;
a means for suggesting an accessory for the device that would help in using the device in the predetermined use.
